(19) United States
(12) Patent Application Publication
(10) Pub. No.: US 2014/0315569 A1
(43) Pub. Date: Oct. 23, 2014

(54) Positioning System in a Wireless Communication Network

(71) Applicant: INTERNATIONAL BUSINESS MACHINES CORPORATION, Armonk, NY (US)

(72) Inventors: Guy Feigenblat, Givataym (IL); Omri Fuchs, Ramat Gan (IL); Tommy Sandbank, Herzliyya (IL)

(73) Assignee: International Business Machines Corporation, Armonk, NY (US)

(21) Appl. No.: 13/867,084

(22) Filed: Apr. 21, 2013

(51) Int. Cl. G01S 11/06; H04W 24/08

(52) U.S. Cl. CPC G01S 11/06; H04W 24/08
USPC 455/456.1

(57) ABSTRACT

Machines, systems and methods for determining position of a target device in a target area are provided. The method comprises positioning sensors 1 through N in a target area, wherein a sensor counts the number of data frames transmitted by a target device and captured at the sensor during a time period; calculating relative captured frame count (RCFC) values for sensors 1 through N for the target device; and comparing the calculated RCFC values for the target device with pre-existing RCFC values calculated for a plurality of sample points in the target area to find at least X points from among the plurality of sample points that are most similar to the calculated RCFC values for the target device.

### CROSS-REFERENCE TO RELATED APPLICATIONS

The present application is related to U.S. application Ser. No. 13/867081, filed on Apr. 21, 2013, Attorney Docket No. IL920120104US1 and U.S. application Ser. No. 13/867082, filed on Apr. 21, 2013, Attorney Docket No. IL920120105US1. The content of both of the above-noted applications is incorporated herein by reference in entirety.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to a positioning system in a wireless communication network and, more particularly, to determining the position of a wireless communication device in a communication network environment with accuracy.

### BACKGROUND

Different schemes have been implemented to detect the position of a wireless communication device in a wireless communication network (e.g., a Wifi network). A common approach requires a software application to be installed and activated on a target device to collect location data stored on the device. Another approach is to capture relevant data provided by one or more communication hubs (e.g., routers) in the Wifi network.

The captured data generally includes or is related to the strength (e.g., Received Signal Strength Indicator or RSSI) of one or more signals at one or more points in the Wifi network. The location of a target device in the network can be calculated according to the RSSI data. The retrieval and use of RSSI data may require permission from system administrators and may thus be burdensome. Further, it is desirable to improve the accuracy of a positioning system that solely relies on RSSI data.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

Machines, systems and methods for determining position of a target device in a target area are provided. In one embodiment, the method comprises positioning sensors 1 through N in a target area, wherein a sensor counts the number of data frames transmitted by a target device and captured at the sensor during a time period; calculating relative captured frame count (RCFC) values for sensors 1 through N for the target device; and comparing the calculated RCFC values for the target device with pre-existing RCFC values calculated for a plurality of sample points in the target area to find at least X points from among the plurality of sample points that are most similar to the calculated RCFC values for the target device.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an example network environment in accordance with one or more embodiments, wherein a communicate device may be connected to a wireless network.

FIG. 2 is an exemplary flow diagram of a method of determining the approximate position of a device, in accordance with one embodiment.

FIG. 3 is another exemplary flow diagram of a method of determining the approximate position of a device, in accordance with one embodiment.

FIGS. 4A and 4B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

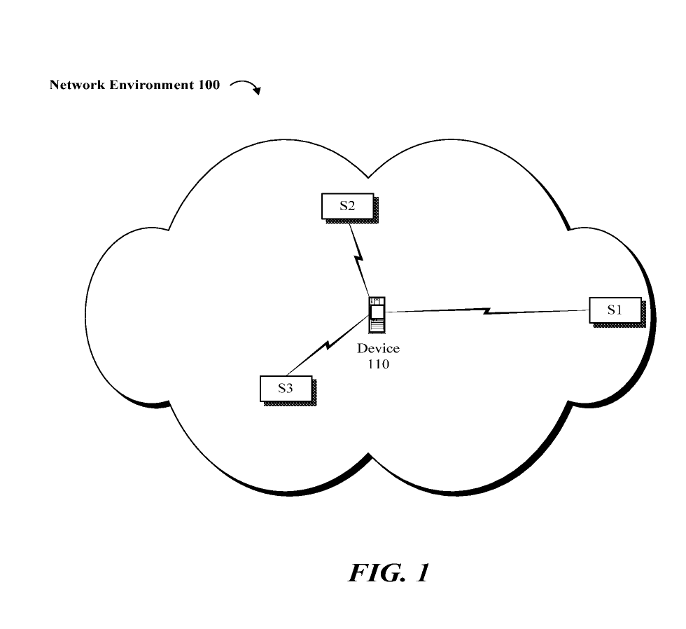

Referring to FIG. 1, an example network environment 100 is illustrated in which device 110 preferably wirelessly connects to a network (not shown) to communicate with other devices connected to the network. In accordance with one embodiment, the physical position of device 110 in network environment 100 may be calculated, using information collected from a plurality of sensors (e.g., S1, S2, S3, . . . ) located in the network environment 100.

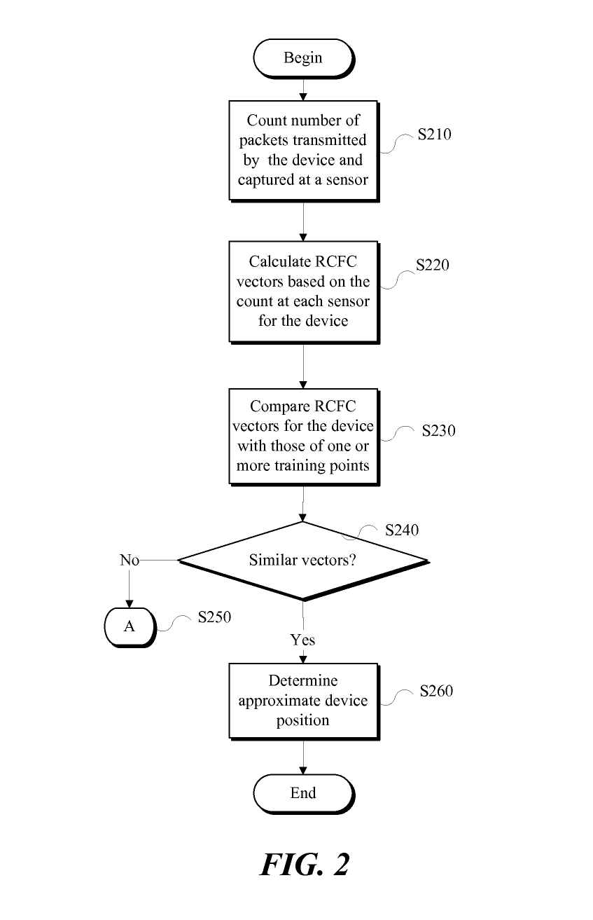

Referring to FIG. 2, in one implementation, the sensors are configured to count the number of packets received or captured by a sensor from among the packets transmitted by a device 110 over one or more communication channels (e.g., Wifi channels) in the network (S210). A relative capture frame count (RCFC) may be calculated for device 110 (S220), desirably and optionally, at one or more sensors by dividing the number of CFCs for device 110 (in a specific period of time P as counted by a sensor) by the sum of CFC counted for device 110, in the same period P, by the sensors:

[symbol]

For example, if three sensors S1, S2 and S3 are located in the network environment 100 and for a device D1, three CFCs are measured at each sensor, respectively, such that: CFCS=4, CFCS2=10 and CFCS3=6, then RCFCS1=4/20, RCFCS2=10/20, and RCFCS3=6/20. Accordingly, a RCFC vector for device D1 may be calculated as V={RCFCS1, RCFCS2, RCFCS3}={0.2, 0.5, 0.3}.

The RCFC vector provides an indication of distance between a device 110 and one or more sensors, where a larger RCFC for a sensor is an indication of a shorter distance between device 110 and the corresponding sensor. In the above scenario, vector V illustrates that device 110 is closest to S2 and farthest from S1, for example. To determine the physical location of device 110 in the network environment 100 based on the device's RCFC vectors, an empirical system such as a machine learning pattern recognition system implemented based on a K-nearest-neighbor (KNN) algorithm may be used.

KNN refers to a method for classifying objects based on closest training examples in a target space and relies on instance-based learning, where a training or learning function is approximated locally and computations are deferred until the objects in the space are classified. An object may be classified by a majority vote of its neighbors, with the object being assigned to the class most common amongst its K nearest neighbors, where K is a positive and preferably small number.

For example, consider an environment where there are N training points and S sensors, such that S defines the length of a vector (e.g., one value per sensor), where a training point 1 through N has one vector with S members. When the location for a device is to be determined, one vector with S members for the device is created based on the measurements of the respective RCFC for the device. The vector associated with the device is then compared with the N vectors associated with the training points (S230).

The coordinates of K points with most similar vectors are used to determine the approximate coordinates for the device (S240). If there is no or little similarity between the vectors compared an error detection scheme may be invoked (S250). As a specific example, there may be 20 sensors and 100 training points, where k=3 means that from the 20 sensors, data from 100 points are collected. Each such point has a vector with the size 20. To calculate the approximate coordinates for a device, the vector for the device is measured against the vectors of the 100 training points and the 3 points that are most similar are used to return the approximate coordinates for the device.

Accordingly, in one implementation, an empirical self-leaning system may be used, where the approximate position of device 110 with respect to the sensors in network environment 100 are calculated by comparing the recorded RCFC value for the respective sensor with values measured during a sampling phase (S260). In more detail, during the sampling phase, RCFC values for K points in network environment 100 are measured and recorded for one or more target sensors in network environment 100. For example, if N sensors are positioned in network environment 100, for a point, N RCFC values may be recorded.

During the sampling phase, the sensors' RCFC value calculated for a point i (e.g., for i: 1 through K) may be recorded along with coordinates of point i in a data structure, for example. The recorded RCFC values for points 1 through K may be later compared to the calculated RCFC values collected for device 110 (relative to the target sensors) to empirically determine the approximated coordinates of device 110 in the network environment 100. In one example implementation, the RCFC values for each sensor measured during the sampling phase may be recorded in a data structure such as a lookup table for quick retrieval.

The above process (e.g., as disclosed with respect to the use of the KNN algorithm) may be repeated for the other sensors in network environment 100 to determine the coordinates of device 110 in the network environment 100 based on the calculated values in the RCFC vector for device 110. Once the device's coordinates based on values calculated by the one or more sensors in the network environment 100 is determined, then a process may be used to determine the a more accurate coordinates for device 110 in network environment 100 based on the collective set of values calculated for the plurality of sensors. Naturally, the larger the number of sensors utilized, the more accurate the position calculated for device 110.

In summary, the process used for determining the position of the device 110 is based on comparing the RCFC vector calculated for the device with RCFC vectors calculated during the sampling phase for the K points in network environment 100. A similarity measurement is applied between the data included in the RCFC vector of device 110 to match the location of the device 110 with the location of one or more of the K points considered during the sampling phase. The K points with RCFC vectors that are most similar to the RCFC vector of the device 110 are selected, wherein the x, y coordinates of the K points are collectively measured (e.g., an average of the coordinates are calculated) to determine the approximate location of the device 110.

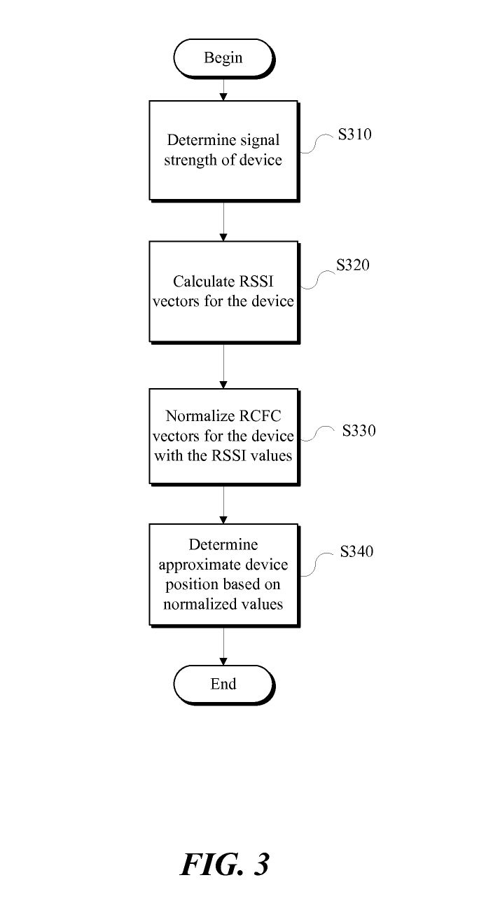

Referring to FIG. 3, to increase the accuracy of the positioning calculation, in addition to the RCFC vector, the signal strength received at one or more sensors or at device 110 may be used to better determine the position of device 110 in network environment 100. The calculation may be performed by determining the received signal strength indicator (RSSI) for device 110 (S310). Accordingly, device 110 may be associated with an RCFC vector (that includes RCFC values for a plurality of sensors for device 110) and also a RSSI vector (that includes RSSI values for the same device) (S320).

In one embodiment, the RCFC values for a device may be normalized based on the RSSI values for device 110 (S330). Depending on implementation, a machine learning or empirical method (e.g., the KNN algorithm) may be applied to the resulting normalized values to achieve more accurate results for determining the position of the devices in network environment 100 (S340).

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

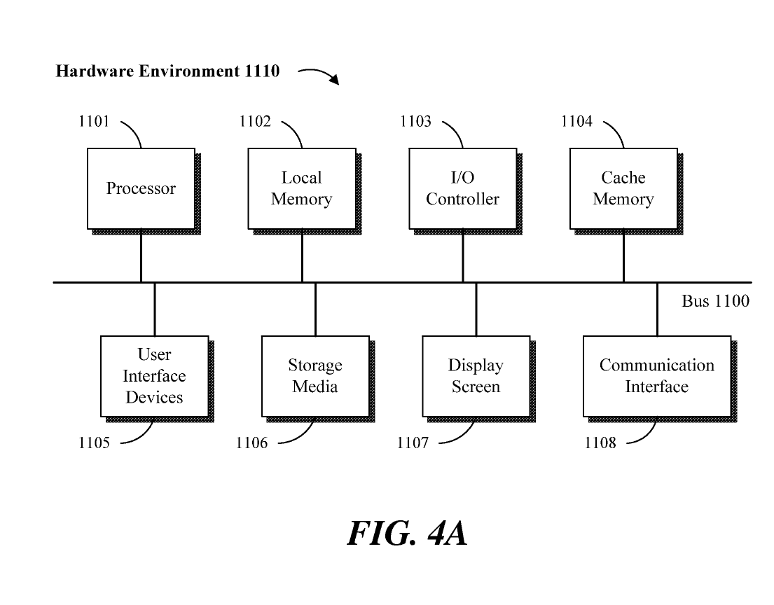

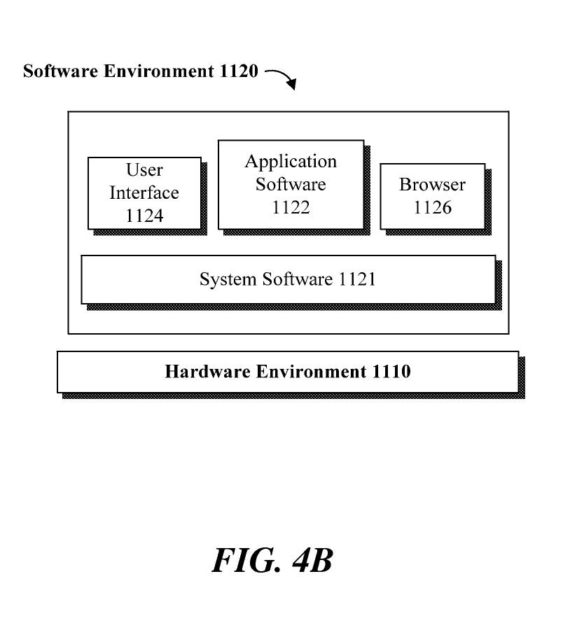

Referring to FIGS. 4A and 4B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 4A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 4B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method for determining position of a target device in a target area, the method comprising:
positioning sensors 1 through N in a target area, wherein a sensor counts the number of data frames transmitted by a target device and captured at the sensor during a time period;
calculating relative captured frame count (RCFC) values for sensors 1 through N for the target device; and
comparing the calculated RCFC values for the target device with pre-existing RCFC values calculated for a plurality of sample points in the target area to find at least X points from among the plurality of sample points that are most similar to the calculated RCFC values for the target device.

2. The method of claim 1, wherein position of the target device in the target area is determined based on position information available for the at least X points.

3. The method of claim 1, wherein a K-nearest-neighbor (KNN) algorithm is used to find the at least X points.

4. The method of claim 1, wherein position of the target device in the target area is determined based on coordinates of the at least X points in the target area.

5. The method of claim 1, wherein an RCFC vector is associated with the target device, such that the RCFC vector includes RCFC values for sensors 1 through N for the target device.

6. The method of claim 5, wherein an RCFC vector is associated with a sample point, such that the vector includes RCFC values for sensors 1 through N for the sample point.

7. The method of claim 6, wherein the RCFC vector associated with the target device is compared with the RCFC vectors for a plurality of sample points.

8. The method of claim 7, wherein K sample points are selected that have the most similar RCFC vectors to the RCFC vector associated with the target device.

9. The method of claim 5, wherein a received signal strength indicator (RSSI) value is calculated for the target device at sensors 1 through N.

10. The method of claim 9, wherein the RCFC values calculated for the RCFC vector associated with the device are normalized according to the calculated RSSI values.

11. A system for determining position of a target device in a target area, the system comprising:
a logic unit for positioning sensors 1 through N in a target area, wherein a sensor counts the number of data frames transmitted by a target device and captured at the sensor during a time period;
a logic unit for calculating relative captured frame count (RCFC) values for sensors 1 through N for the target device; and
a logic unit for comparing the calculated RCFC values for the target device with pre-existing RCFC values calculated for a plurality of sample points in the target area to find at least X points from among the plurality of sample points that are most similar to the calculated RCFC values for the target device.

12. The system of claim 11, wherein position of the target device in the target area is determined based on position information available for the at least X points.

13. The system of claim 11, wherein a K-nearest-neighbor (KNN) algorithm is used to find the at least X points.

14. The system of claim 11, wherein position of the target device in the target area is determined based on coordinates of the at least X points in the target area.

15. The system of claim 11, wherein an RCFC vector is associated with the target device, such that the RCFC vector includes RCFC values for sensors 1 through N for the target device.

16. A computer program product comprising a computer readable storage medium having a computer readable program, wherein the computer readable program when executed on a computer causes the computer to:
position sensors 1 through N in a target area, wherein a sensor counts the number of data frames transmitted by a target device and captured at the sensor during a time period;
calculate relative captured frame count (RCFC) values for sensors 1 through N for the target device; and
compare the calculated RCFC values for the target device with pre-existing RCFC values calculated for a plurality of sample points in the target area to find at least X points from among the plurality of sample points that are most similar to the calculated RCFC values for the target device.

17. The computer program product of claim 16, wherein position of the target device in the target area is determined based on position information available for the at least X points.

18. The computer program product of claim 16, wherein a K-nearest-neighbor (KNN) algorithm is used to find the at least X points.

19. The computer program product of claim 16, wherein position of the target device in the target area is determined based on coordinates of the at least X points in the target area.

20. The computer program product of claim 16, wherein an RCFC vector is associated with the target device, such that the RCFC vector includes RCFC values for sensors 1 through N for the target device.
